(19) United States
(12) Patent Application Publication
(10) Pub. No.: US 2025/0078357 A1
(43) Pub. Date: Mar. 6, 2025

(54) METHOD FOR GENERATING A MULTIMEDIA CONTENT, COMPUTER DEVICE AND STORAGE MEDIUM

(71) Applicant: Beijing Zitiao Network Technology Co., Ltd., Beijing (CN)

(72) Inventors: Hao SHEN, Beijing (CN); Jun LI, Beijing (CN); Aonan TAN, Beijing (CN); Ran ZHANG, Beijing (CN)

(21) Appl. No.: 18/793,736

(22) Filed: Aug. 2, 2024

(30) Foreign Application Priority Data
Sep. 1, 2023 (CN) 202311126185.6

(51) Int. Cl. G06T 11/60; G06F 40/166; G06F 40/30

(52) U.S. Cl. CPC G06T 11/60; G06F 40/30; G06F 40/166

(57) ABSTRACT

A method for generating a multimedia content, a computer device and a storage medium are provided. The method includes: receiving generation indication information for a multimedia content and displaying multimedia outline information matched with the generation indication information, the multimedia outline information including at least one outline title and an initial content proportion corresponding to a target content under each outline title, the multimedia outline information being determined according to dimension information corresponding to the generation indication information under at least one attribute dimension; acquiring a target content proportion of the target content under each outline title in response to a proportion adjustment operation for the initial content proportion; and displaying a first multimedia content matched with the generation indication information; the first multimedia content being generated according to the target content proportion corresponding to each outline title.

### CROSS-REFERENCE TO RELATED APPLICATION

The present application claims the priority of the Chinese patent application No. 202311126185.6 filed on Sep. 1, 2023, and the content disclosed in the above Chinese patent application is incorporated in its entirety as a part of the present application.

### TECHNICAL FIELD

The present disclosure relates a method for generating a multimedia content, a computer device and a storage medium.

### BACKGROUND

In an intelligent question-answer scenario, a user may have the requirement to use models to generate a multimedia content. For example, after the user submits a question including the generation requirement, the user can acquire a multimedia answer result provided by the model for this question. However, if an answer effect of the answer result provided by the model is not good, resulting in that the user requires to modify the answer result, it is necessary to re-enter the adjusted question to acquire an answer result meeting expectations, thereby adjusting the answer result.

### SUMMARY

Embodiments of the present disclosure at least provides a method and apparatus for generating a multimedia content, a computer device and a storage medium.

An embodiment of the present disclosure provides a method for generating a multimedia content, including:
receiving generation indication information for a multimedia content and displaying multimedia outline information matched with the generation indication information, the multimedia outline information including at least one outline title and an initial content proportion corresponding to a target content under each outline title, the multimedia outline information being determined according to dimension information corresponding to the generation indication information under at least one attribute dimension;
acquiring a target content proportion of the target content under each outline title in response to a proportion adjustment operation for the initial content proportion; and
displaying a first multimedia content matched with the generation indication information; the first multimedia content being generated according to the target content proportion corresponding to each outline title.

In one possible implementation, the multimedia outline information further includes a preview content under each outline title; the preview content is summary information in the target content under the outline title, and is used to characterize a correlation degree between the target content under the outline title and the generation indication information;
after displaying the multimedia outline information matched with the generation indication information, the method further includes:
receiving a modification operation for any of the outline titles to acquire an updated outline title; and
replacing the modified outline title with the updated outline title and replacing the preview content under the modified outline title with the preview content under the updated outline title.

In one possible implementation, after the displaying the multimedia outline information matched with the generation indication information, the method further includes:
in response to triggering a generation operation, displaying a second multimedia content matched with the generation indication information, the second multimedia content being generated according to the initial content proportion corresponding to each outline title.

In one possible implementation, the multimedia outline information is determined according to the following steps:
performing semantic recognition on the generation indication information by using an artificial intelligence model, to determine first semantic information of the generation indication information;
determining, according to the first semantic information, corresponding dimension information under a plurality of attribute dimensions and content materials related to the dimension information; and
generating the multimedia outline information according to the dimension information and the content materials.

In one possible implementation, the attribute dimension includes at least one selected from the group consisting of a vertical field dimension, a timeliness dimension, an application scenario dimension, a content opposition dimension and a content type dimension.

In one possible implementation, when the generation indication information is article generation indication information and the attribute dimension includes the content type dimension, the multimedia outline information is determined according to the following steps:
performing semantic recognition on the article generation indication information by using the artificial intelligence model to determine second semantic information of the article generation indication information;
determining, according to the second semantic information, an article type of an article to be generated that is matched with the article generation indication information under the content type dimension, and article materials that are matched with the article generation indication information; and
generating the multimedia outline information according to the article type and the article materials.

In one possible implementation, the generating the multimedia outline information according to the article type and the article materials includes:
determining respective target outlines corresponding to the article type according to the article type and a pre-established association relationship between the article type and the outline; and
determining the outline title corresponding to each target outline, and the initial content proportion and the preview content corresponding to each outline title, according to the article materials.

In one possible implementation, the receiving generation indication information for a multimedia content and displaying multimedia outline information matched with the generation indication information includes:
receiving the generation indication information, and displaying the multimedia outline information and a proportion adjustment identifier;
the acquiring a target content proportion of the target content under each outline title in response to a proportion adjustment operation for the initial content proportion includes:
placing respective the initial content proportions in an editable state in response to triggering the proportion adjustment identifier; and
acquiring the target content proportion corresponding to each outline title in response to an editing operation for the initial content proportion in the editable state,
wherein a sum of the target content proportions corresponding to the respective outline titles is a preset value.

In one possible implementation, after displaying the first multimedia content matched with the generation indication information, the method further includes:
displaying the target content proportion corresponding to each outline title in response to the editing operation for the first multimedia content;
acquiring a new target content proportion corresponding to each outline title in response to the adjustment operation for the target content proportion; and
displaying a third multimedia content, the third multimedia content being generated according to the new target content proportion corresponding to each outline title by using an artificial intelligence model.

An embodiment of the present disclosure provides an apparatus for generating a multimedia content, including:
a first display module, configured to receive generation indication information for a multimedia content and display multimedia outline information matched with the generation indication information, the multimedia outline information including at least one outline title and an initial content proportion corresponding to a target content under each outline title, the multimedia outline information being determined according to dimension information corresponding to the generation indication information under at least one attribute dimension;
an acquisition module, configured to acquire a target content proportion of the target content under each outline title in response to a proportion adjustment operation for the initial content proportion; and
a second display module, configured to display a first multimedia content matched with the generation indication information, the first multimedia content being generated according to the target content proportion corresponding to each outline title.

An optional implementation of the present disclosure provides a computer device, including at least one processor and at least one memory, wherein the at least one memory stores machine-readable instructions executable by the at least one processor, and the at least one processor is used for executing the machine-readable instructions stored in the at least one memory, and when the machine-readable instructions are executed by the at least one processor, the processor executes the above method for generating a multimedia content or any step of any possible implementation of the method.

An optional implementation of the present disclosure provides a non-transient computer-readable storage medium, wherein the computer-readable storage medium has stored thereon a computer program, and when the computer program is run by a computer device, the computer device executes the above method for generating a multimedia content or any step of any possible implementation of the method.

The description of the effects of the apparatus for generating a multimedia, the computer device, and the computer-readable storage medium mentioned above can be found in the description of the method for generating a multimedia content mentioned above, which will not be repeated here.

### BRIEF DESCRIPTION OF DRAWINGS

In order to provide a clearer explanation of the technical solution of the embodiments of the present disclosure, a brief introduction will be given below to the accompanying drawings required in the embodiments. The accompanying drawings are incorporated into the specification and form a part of the specification. These drawings illustrate embodiments that comply with the present disclosure and are used together with the specification to illustrate the technical solution of the present disclosure. It should be understood that the following drawings only illustrate certain embodiments of the present disclosure, and therefore should not be regarded as limiting the scope. For those skilled in the art, other relevant drawings can be obtained based on these drawings without creative efforts.

FIG. 1 shows a flowchart of a method for generating a multimedia content provided by an embodiment of the present disclosure;

FIG. 2 shows a schematic diagram of a process of generating a first multimedia content provided by an embodiment of the present disclosure;

FIG. 3 shows a schematic diagram of an apparatus for generating a multimedia content provided by an embodiment of the present disclosure; and

FIG. 4 shows a schematic structural diagram of a computer device provided by an embodiment of the present disclosure.

### DETAILED DESCRIPTION

In order to clarify the purpose, technical solution, and advantages of the embodiments of the present disclosure, the following will provide a clear and complete description of the technical solution in the embodiments of the present disclosure in conjunction with the accompanying drawings. Obviously, the described embodiments are only a part of the embodiments of the present disclosure, not all of them. Generally, the components of the embodiments of the present disclosure described and shown here can be arranged and designed in various different configurations. Therefore, the following detailed description of the embodiments of the present disclosure is not intended to limit the scope of the claimed protection, but only to represent the selected embodiments of the present disclosure. Based on the embodiments of the present disclosure, all other embodiments obtained by those skilled in the art without creative efforts fall within the scope of protection of the present disclosure.

In addition, the terms “first”, “second”, etc. in the description and claims of the present disclosure, as well as the accompanying drawings, are used to distinguish similar objects and do not necessarily need to be used to describe a specific order or sequence. It should be understood that the data used in this way can be interchanged in appropriate cases, so that the embodiments described here can be implemented in order other than those illustrated or described here.

The term “a plurality or several” mentioned herein refers to two or more. “And/or” describes the association relationship of the associated object, indicating that there can be three types of relationships, for example, A and/or B can represent: the existence of A alone, the coexistence of A and B, and the existence of B alone. The character “/” generally indicates that the related object before and after is an “OR” relationship.

The inventors of the present invention have been found that although an artificial intelligence model provided in an intelligent scenario can output a targeted answer according to a question inputted by a user, due to the fact that the perspectives, ways and contents of the user's question are often complex and changeable and that different users' questions are even less common, no matter how the training effect of the model is, there will always be cases where the answer result provided by the model does not meet the expectations of the users. In this case, a conventional way is to re-enter the adjusted question by the user to try to acquire an answer result meeting the expectations. However, in this way, the flexibility and efficiency of modifying the answer results are affected, and a path for acquiring the expected answer results is extended, which affects the question and answer experience of the user.

Based on the above research, the present disclosure provides a method and an apparatus for generating a multimedia content, a computer device and a storage medium. After generation indication information is received, a content structure and a content summary of the multimedia content to be generated may be displayed by displaying multimedia outline information such as an outline title and an initial content proportion, thus facilitating the user to quickly understand the multimedia content to be generated. By acquiring a target content proportion in response to a proportion adjustment operation and displaying a first multimedia content generated by using the target content proportion, the content structure and specific content of the multimedia content to be generated can be adjusted in time by using the target content proportion corresponding to respective outline titles, so as to quickly obtain the first multimedia content that is more in line with expectations. Compared with the case in which the expected result can only be obtained by re-entering the adjusted question, the embodiment of the present disclosure can acquire in time the adjustment information (i.e., the target content proportions) for the multimedia content in a process of generating the multimedia content, by displaying the outline titles and the initial content proportions of the multimedia content to be generated and receiving modifications for the initial content proportions. Then, the content structure and content information of the multimedia content to be generated are modified in time by using the adjustment information, and the first multimedia content meeting the expectations is outputted. By receiving the adjustment information in the generating process, the flexibility of modification can be improved, and the path for acquiring the expected multimedia content can be effectively shortened, thus improving the efficiency of generating the multimedia content.

The shortcomings of the above solution are the results obtained by the inventors after practice and careful study. Therefore, the discovery process of the above problems and the solutions proposed in the present disclosure below should be the contributions made by the inventors to the present disclosure in the course of the present disclosure.

It should be noted that like reference numbers and letters refer to like items in the following drawings, and thus, once an item is defined in one drawing, it need not be further defined or explained in subsequent drawings.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For the convenience of understanding this embodiment, firstly, a method for generating a multimedia content disclosed in this embodiment of the present disclosure is introduced in detail. An executing subject of the method for generating a multimedia content provided in this embodiment of the present disclosure is generally a terminal device or other processing device with certain computing power, where the terminal device may be user equipment (UE), a mobile device, a user terminal, a terminal, a personal digital assistant (PDA), a handheld device, a computer device, etc. In some possible implementations, the method for generating a multimedia content can be implemented by a processor calling computer-readable instructions stored in a memory.

The method for generating a multimedia content provided by the embodiment of the present disclosure will be described below by taking the executing subject as a client, for example.

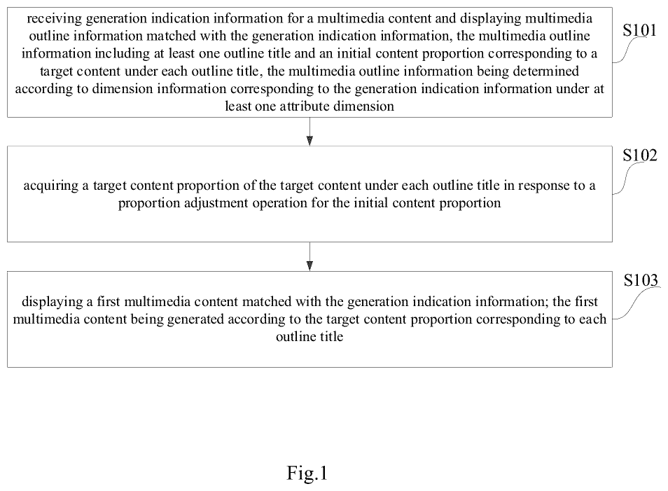

As shown in FIG. 1, a flowchart of a method for generating a multimedia content provided by an embodiment of the present disclosure may include the following steps:

S101: receiving generation indication information for a multimedia content and displaying multimedia outline information matched with the generation indication information, the multimedia outline information including at least one outline title and an initial content proportion corresponding to a target content under each outline title, the multimedia outline information being determined according to dimension information corresponding to the generation indication information under at least one attribute dimension.

Here, the generation indication information may be indication information for instructing the generation of any type of multimedia content. The multimedia content may be, for example, articles, videos, pictures, audios and the like. Exemplarily, the generation indication information may be a question entered by a user on a dialog page, for example, help me conceive a file of the “XX” event, help me generate a video of the “XX” event, and the like.

The multimedia outline information is generated according to the dimension information under at least one attribute dimension corresponding to the generation indication information, and the attribute dimension may be specified in advance. Specifically, the attribute dimension may include at least one selected from the group consisting of a vertical field dimension, a timeliness dimension, an application scenario dimension, a content opposition dimension and a content type dimension. A vertical field is used to indicate a vertical field to which the generation indication information belongs, such as an entertainment field, a military field, an e-commerce field, a life service field, a game field, an operation field, etc.; the timeliness dimension is used to indicate the timeliness of the generation indication information, for example, whether an event indicated by the generation indication information is a hot event, a long-term event, or within a validity period; the application scenario dimension is used to indicate an application scenario to which the generation indication information belongs, such as a grass planting scenario, a science popularization scenario, an academic question-and-answer scenario, a novel scenario, etc.; the content opposition dimension is used to indicate whether the generation indication information can be debated; and the content type dimension is used to indicate the type of a generated multimedia content indicated by the generation indication information, such as an article type, a video type, a graphic type, etc. The dimension information is attribute information that the generation indication information has under the attribute dimension. For example, when the generation indication information belongs to the entertainment field, the dimension information under the vertical field dimension is the entertainment field.

The multimedia outline information may include respective outline titles corresponding to the multimedia content used to answer the generation indication information and an initial content proportion of a target content under each outline title, where if all the multimedia contents used to answer the generation indication information have been generated before the multimedia outline information is displayed, the target content may be the generated multimedia content corresponding to respective outline titles. If a part of the multimedia contents used to answer the generation indication information is not generated before the multimedia outline information is displayed, the target content may be the multimedia content to be generated corresponding to respective outline titles. Different outline titles correspond to different parts of the multimedia content used to answer the generation indication information and are used to indicate the titles of the corresponding parts of the content, and all the outline titles together can reflect the content structure of the multimedia content. For example, the outline title in the multimedia outline information may be a background of the event, a course of the event, responses of all parties, the responses of the disputing party, an impact of the event, etc. The numbers and contents of outline titles corresponding to different multimedia contents are different.

The initial content proportion is used to indicate a target content under each outline title, and to display proportions of all the contents of the multimedia content used to answer the generation indication information The proportions may be determined according to the generation indication information by using the artificial intelligence model. One outline title corresponds to one initial content proportion, and the sum of the content proportions corresponding to the respective outline titles is equal to a preset value, where the preset value may be 100%.

In implementing, it is used to input the generation indication information in the display of the dialog page at the client; after receiving the generation indication information, the client may send the generation indication information to a server; and the server may use the pre-trained artificial intelligence model to obtain the multimedia outline information according to the dimension information corresponding to the generation indication information under respective attribute dimensions. Here, the artificial intelligence model can be used to directly output all the multimedia outline information, and the server can also acquire all the multimedia content outputted by the artificial intelligence model and determine corresponding multimedia outline information according to the multimedia content. Furthermore, the server can feed back the multimedia outline information to the client, and the client can display the multimedia outline information in the dialog page after receiving the multimedia outline information fed back.

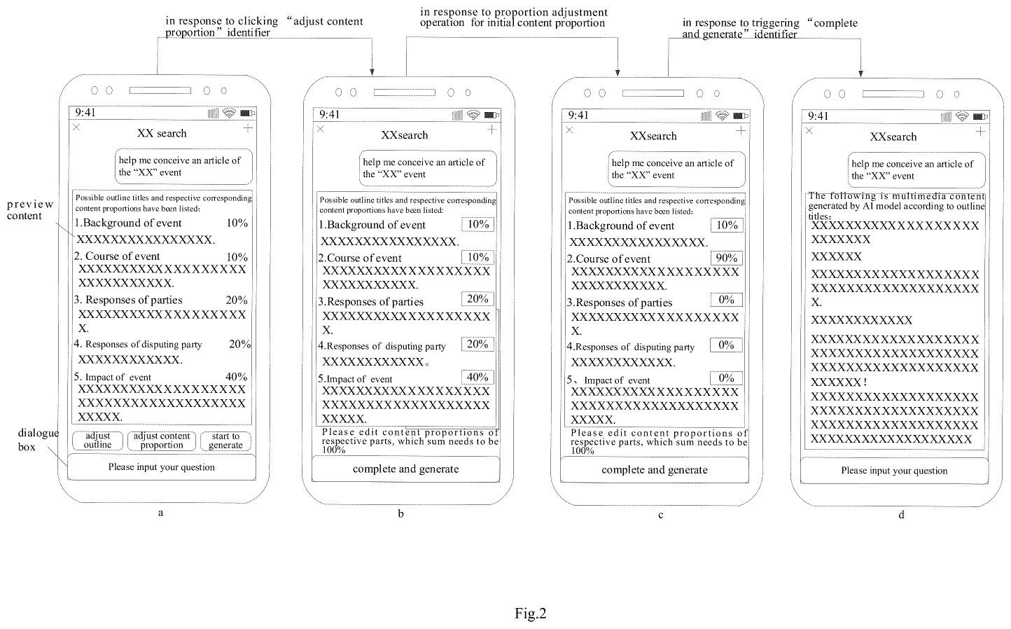

As shown in FIG. 2, it is a process diagram of generating the first multimedia content provided by an embodiment of the present disclosure, where “a” in FIG. 2 shows a schematic diagram of the displayed multimedia outline information, “b” in FIG. 2 shows a schematic diagram of a proportion adjustment page, “c” in FIG. 2 is a schematic diagram of the target content proportion, and “d” in FIG. 2 is a schematic diagram of the generated first multimedia content. In “a”, the generation indication information is “Help me conceive an article about XX event”, and the multimedia outline information includes five outline titles, and the initial content proportions and preview contents corresponding to the outline titles (which will be introduced later). The five outline titles are: 1. Background of an event, with the corresponding initial content proportion of 10%; 2. Course of the event, with the corresponding initial content proportion of 10%; 3. Responses of all parties, with the corresponding initial content proportion of 20%; 4. Responses of the disputing party, with the corresponding initial content proportion of 20%; and 5. Impact of the event, with the corresponding initial content proportion of 40%. In “a” and “d” in FIG. 2, a dialog box is also displayed, which is used for receiving the new generation indication information inputted by the user.

S102: acquiring a target content proportion of the target content under each outline title in response to a proportion adjustment operation for the initial content proportion.

Here, the proportion adjustment operation may be an adjustment operation for at least one initial content proportion displayed, and the target content proportion is the content proportion obtained after adjusting the initial content proportion.

In implementing, the initial content proportion can be placed into an editable state in response to the user's clicking operation on the initial content proportion corresponding to any of displayed outline titles, and then the target content proportion inputted by the user for replacing the initial content proportion may be acquired. Here, it should be noted that before and after the initial content proportion is adjusted, the sum of the content proportions corresponding to the respective outline titles is kept as the preset value. After the user adjusts the initial content proportion corresponding to a certain outline title to the target content proportion, the user may be reminded of adaptively adjusting other initial content proportions to ensure that the sum of the content proportions corresponding to the respective outline titles is a preset value; or, the initial content proportion may be adaptively adjusted according to the target content proportion and the unadjusted initial content proportion, for example, the unadjusted initial content proportion is adaptively adjusted according to the correlation degree between the outline title corresponding to the initial content proportion adjusted by the user and the outline titles corresponding to other unadjusted initial content proportions. Exemplarily, after the initial content proportion of “2. Course of event” in the outline title shown in “a” of FIG. 2 is adjusted from 10% to 40%, according to the correlation degree between this outline title and the other outline titles, the initial content proportion corresponding to “1. Background of event” is not adjusted, the initial content proportion of “3. Responses of parties” is adaptively adjusted from 20% to 10%, the initial content proportion of “4. Responses of disputing party” is adaptively adjusted from 20% to 10%, and the initial content proportion of “5. Impact of event” is adaptively adjusted from 40% to 30%.

In an embodiment, S101 can be implemented according to the following steps:
receiving the generation indication information and displaying the multimedia outline information and a proportion adjustment identifier.

Here, the proportion adjustment identifier is used to adjust the initial content proportion after being triggered.

In implementing, after receiving the generation indication information, the client may send the generation indication information to the server, and then may acquire the multimedia outline information fed back by the server; then, the client may display the proportion adjustment identifier in the dialog page while displaying the multimedia outline information. For example, the proportion adjustment identifier may be the “adjust the content proportion” identifier in “a” of FIG. 2.

Further, S102 may be implemented according to the following steps:
placing respective initial content proportions in an editable state in response to triggering the proportion adjustment identifier; acquiring a target content proportion corresponding to each outline title in response to an editing operation for the initial content proportion in the editable state, where the sum of the target content proportions corresponding to the respective outline titles is a preset value.

Here, the operation of triggering the proportion adjustment identifier may be an operation of clicking the proportion adjustment identifier. The editing operation is an operation of modifying the initial content proportion.

In implementing, the proportion adjustment page as shown in “a” of FIG. 2 may be displayed in response to the user clicking the “adjust content proportion” identifier in “a” of FIG. 2. In “b” of FIG. 2, the initial content proportion corresponding to the respective outline titles is placed in an editable state (as shown in “b” of FIG. 2, the initial content proportions are in editing boxes). Then, the target content proportion inputted by the user may be acquired in response to an editing operation for at least one initial content proportion in the editable state. If the user only edits a part of the initial content proportions in editable states, the other initial content proportions may be adaptively adjusted to obtain the target content proportions. If the user has edited all the initial content proportions in the editable states, the respective target content proportions of the outline titles may be acquired without adaptive adjustment. The sum of the respective target content proportions corresponding to the outline titles is equal to 100%.

As shown in “c” of FIG. 2, it is a schematic diagram of a page with adjusted proportions provided by an embodiment of the present disclosure, where a page shown in “c” of FIG. 2 is a page obtained by adjusting the respective initial content proportions in “b” of FIG. 2, where the target content proportion corresponding to the outline title “1. Background of event” is 10%, the target content proportion corresponding to the outline title “2. Course of event” is 90%, and the target content proportions corresponding to the outline titles “3. Responses of parties”, “4. Responses of disputing party” and “5. Impact of event” are 0% respectively.

S103: displaying a first multimedia content matched with the generation indication information; the first multimedia content being generated according to the target content proportion corresponding to each outline title.

Here, the first multimedia content is generated according to the generation indication information and the content material under each outline title in accordance with the target content proportion corresponding to each outline title by using the artificial intelligence model and is used for answering the generation indication information. In the first multimedia content, the content proportion under respective outline titles accords with the target content proportion corresponding to the outline title.

In implementing, after acquiring the target content proportions, the client may send the respective target content proportions to the server, and the server may generate the first multimedia content according to the target content proportions and the generation indication information by using the artificial intelligence model. Then, the server may feedback the generated first multimedia content to the client, and the client may display the first multimedia content in the dialog page after receiving the first multimedia content. As shown in “d” of FIG. 2, it is a schematic diagram for displaying the first multimedia content provided by an embodiment of the present disclosure, where the first multimedia content in “d” of FIG. 2 is generated according to the target content proportion shown in “c” of FIG. 2, and only part of the first multimedia content is shown in “d”, and the first multimedia content that is not displayed may be acquired by delimiting the page shown in “d”.

Optionally, after the target content proportion is acquired, the first multimedia content may be displayed in response to triggering to an editing completion identifier.

The editing completion identifier may be a “complete and generate” identifier shown in “b” and “c” of FIG. 2.

In this way, by modifying the content proportion to generate the multimedia content, the flexibility and controllability of content modification may be improved, and the first multimedia content which is more in line with expectations can be obtained.

In an embodiment, the multimedia outline information further includes a preview content under each outline title; the preview content is summary information in the target content under the outline title and is used to characterize a correlation degree between the target content under the outline title and the generation indication information.

Here, the multimedia outline information may also include the preview content under each outline title, and the preview content is used to characterize summary information of the target content under the outline title. For example, the preview content may be a summarized content generated after summarizing the target content, or the preview content may be used to indicate a theme and key information of the multimedia content to be generated under the outline title. By using the preview content, the correlation degree between the target content under the outline title and the generation indication information can be characterized, so that it is convenient for the user to determine whether the target content under the outline title can meets generation requirements according to the preview content, and then it is convenient for the user to determine whether the initial content proportion corresponding to the outline title needs to be modified. The preview content is usually not long, and it is to help the user quickly understand the outline title and the target content under the outline title.

For example, when the outline title is the background of the event, the preview content may be that on an occasion of XX, Party XX refused to provide XX items to an XX user, but actively distributed XX items to a Y user, which arouse heated discussions.

In implementing, after acquiring the multimedia outline information, the client can display the respective outline titles, the initial content proportion corresponding to each outline title and the preview content corresponding to each outline title in the dialog page. In “a”, “b” and “c” in FIG. 2, the contents under the respective outline titles are the preview contents displayed under the outline titles.

Further, after displaying the multimedia outline information matched with the generation indication information, the method also includes:
receiving a modification operation for any of the outline titles to acquire an updated outline title; and replacing the modified outline title with the updated outline title and replacing the preview content under the modified outline title with the preview content under the updated outline title.

Here, the modification operation is used to modify any of displayed outline titles, and the updated outline title is a title obtained after the outline title is modified.

In implementing, the outline title can be placed in an editable state in response to the clicking operation on any of the outline titles. Or the outline title can be placed in an editable state in response to triggering the outline editing identifier (such as the “adjust outline” identifier shown in “a” of FIG. 2). Then, the modification operation for any outline title in an editable state can be received, and the updated outline title is acquired. For example, the updated outline title “1. Search index of the event” can be acquired in response to the modification operation for “1. Background of the event” in “a” of FIG. 2. Thereafter, the client may send the updated outline title to the server and acquire a preview content generated by the server according to the updated outline title by using the artificial intelligence model. Then, the client can replace the modified outline title with the updated outline title and replace the preview content under the modified outline title with the preview content under the updated outline title. Meanwhile, positions of other outline titles and their corresponding preview contents may be adaptively adjusted according to the length of the preview content under the updated outline title.

As such, the adjustment of the outline title may be implemented, and then the multimedia content may be updated based on the updated outline title.

Optionally, in response to the adjustment of the outline title and the initial content proportion corresponding to the outline title, the multimedia outline information displayed on the dialog page can be updated according to the updated outline title and target content proportion.

In an embodiment, after S102 is executed, in response to triggering a generation operation, a second multimedia content matched with the generation indication information is displayed, the second multimedia content being generated according to the initial content proportion corresponding to each outline title.

Here, the triggering a generation operation may be an operation of triggering a generation identifier, and the generation identifier may be, for example, a “start to generate” identifier shown in “a” of FIG. 2. The content proportions corresponding to the respective outline titles in the second multimedia content accord with the initial content proportions corresponding to the outline titles.

Exemplarily, if it is not necessary to adjust the outline title and the initial content proportion, the second multimedia content generated according to the generation indication information by using the artificial intelligence model according to the initial content proportions may be acquired in response to the operation of clicking the generation identifier, and the second multimedia content may be displayed in the dialog page.

In this way, in the case that the multimedia outline information meets the user's expectations, by displaying the second multimedia content generated according to the initial content proportions, the acquisition efficiency of the multimedia content will not be reduced, and the user can know key information related to the multimedia content used to answer the generation indication information in advance.

In an embodiment, the multimedia outline information may be determined according to the following steps:

Step one: performing semantic recognition on the generation indication information by using an artificial intelligence model, to determine first semantic information of the generation indication information.

In implementing, the generation indication information may be inputted into the pre-trained artificial intelligence model, and the semantic recognition and understanding may be performed on the generation indication information by using the artificial intelligence model to obtain the first semantic information.

Step two: determining, according to the first semantic information, corresponding dimension information under a plurality of attribute dimensions and content materials related to the dimension information.

Here, the content material is a multimedia content material related to the dimension information. For example, when the dimension information is that the event corresponding to the generation indication information has strong timeliness, the content material may be a latest material related to the event, and when the dimension information is an entertainment field, the content material may be a classic content and a popular content in the entertainment field; when the dimension information is that the event corresponding to the generation indication information is an article type, the content material may be various article materials related to the event. It should be understood that the content material under some dimension information may be empty.

In implementing, the dimension information corresponding to the generation indication information under respective attribute dimensions and the content material related to each dimension information may be determined by using the artificial intelligence model according to the first semantic information.

Step three: generating the multimedia outline information according to the dimension information and the content materials.

In implementing, the artificial intelligence model summarizes the dimension information under respective dimension information and obtains the multimedia outline information that is matched with the generation indication information.

Or the artificial intelligence model can sift out usable target dimension information from multiple dimension information according to the dimension information of the generation indication information under the content type dimension, and then generate multimedia outline information according to the content materials under respective target dimension information. For example, when the dimension information of the generation indication information is an article type under the content type dimension, multimedia outline information may be generated according to the content material corresponding to the dimension information under the content opposition dimension, the content material corresponding to the dimension information under the timeliness dimension and the content material corresponding to the dimension information under the article type.

In an embodiment, when the generation indication information is article generation indication information and the attribute dimension includes a content type dimension, the multimedia outline information is determined according to the following steps:
performing semantic recognition on the article generation indication information by using the artificial intelligence model to determine second semantic information of the article generation indication information;
determining, according to the second semantic information, an article type of an article to be generated that is matched with the article generation indication information under the content type dimension, and article materials that are matched with the article generation indication information; and
generating the multimedia outline information according to the article type and the article materials.

Here, the article generation indication information is used to indicate the multimedia content of the generated article type, and the second semantic information is the semantic information of the article generation indication information. The article to be generated is an article used to answer the article generation indication information. The article type is used to indicate a type corresponding to the article to be generated, and different types of articles correspond to different outline titles. The article types may include, for example, a news report article type, an analysis article type, an explanation article type, a debate article type, etc.

In implementing, the article generation indication information may be inputted into the artificial intelligence model, and the artificial intelligence model is used to perform semantic recognition to determine the second semantic information; then, when the dimension information in the content type dimension is determined to be the article type according to the second semantic information, the dimension information in other attribute dimensions may be no longer acquired and determined directly, and all the article materials corresponding to the article to be generated that is matched with the generation indication information can be directly acquired. Thereafter, multimedia outline information (here, the multimedia outline information may be article outline information) may be generated by using the article materials and the article types, and the multimedia outline information may include a plurality of article outline titles, and an initial content proportion and a preview content of each article outline title. Optionally, when generating the multimedia outline information, the acquired article material may also be used to generate an initial article for answering the article generation indication information; if the initial content proportions are not modified, the initial article may be directly displayed as the first multimedia content on the dialog page; if the initial content proportions are modified, a target article may be generated according to the article materials in accordance with the target content proportions and the target article is displayed as the first multimedia content on the dialog page.

In an embodiment, the step of “generating the multimedia outline information according to the article type and the article materials” may be implemented according to the following steps:

Determining respective target outlines corresponding to the article type according to the article type and a pre-established association relationship between the article type and the outline.

Here, the association relationship between various article types and the outlines may be pre-established. For example, when the article type is the news report article type, the outline indicated by the association relationship may include a title, a date, an introduction, an event overview, introduction of important persons, event details, conclusion, etc.; when the article type is the analysis article type, the outline indicated by the association relationship may include a title, an introduction, a problem statement, analysis details, explanation results, conclusion, etc.; when the article type is an explanation article type, the outline indicated by the association indication may include a title, an introduction, a purpose, explanation details, examples or evidences, conclusion, etc.; and when the article type is the debate article type, the outline indicated by the association relationship can include a title, an introduction, a debating position statement, arguments 1−n, refutations 1−m, conclusions, etc., where both n and m are positive integers.

In implementing, respective target outlines may be determined according to the article type and association relationship corresponding to the article generation indication information.

The outline title corresponding to each target outline, and the initial content proportion and the preview content corresponding to each outline title are determined, according to the article materials.

In implementing, corresponding sub-materials under each target outline may be determined according to the article materials, and an outline title corresponding to the target outline may be determined according to the sub-materials. Meanwhile, the initial content proportion corresponding to each outline title may be determined according to the fitting degree between each outline title and the article generation indication information, and the preview content corresponding to each outline title may be determined according to the article material. Thereafter, the respective outline titles, the initial content proportions corresponding to the respective outline titles and the preview contents may be used as multimedia outline information matched with the article generation indication information.

In an embodiment, in order to further improve the modification flexibility of the answer result, after the first multimedia content is displayed, the following steps may be performed:

S1: displaying the target content proportion corresponding to each outline title in response to the editing operation for the first multimedia content.

Here, the editing operation for the first multimedia content may be an operation of double-clicking the first multimedia content or an operation of editing an identifier in an initial dialog page.

In implementing, after the first multimedia content is displayed, the target content proportion corresponding to each outline title may be displayed in the dialog page in response to the editing operation for the first multimedia content, and the target content proportion may be set in an editable state.

Optionally, while displaying the target content proportion, respective outline titles in the editable states can also displayed.

S2: acquiring a new target content proportion corresponding to each outline title in response to the adjustment operation for the target content proportion.

In implementing, a new target content proportion corresponding to each outline title may be acquired in response to the operation of modifying respective target content proportions.

Optionally, the modification operation for the outline title may be acquired at the same time, and the updated outline title may be obtained.

S3: displaying a third multimedia content, the third multimedia content being generated according to the new target content proportion corresponding to each outline title by using the artificial intelligence model.

Here, the third multimedia content may be a multimedia content generated according to the new target content proportion corresponding to each outline title by using the artificial intelligence model.

In implementing, after being acquired, the new target content proportion and/or the updated outline title may be sent to the server, and the server may use the artificial intelligence model to generate new multimedia content for answering the generation indication information according to the new target content proportion and/or the updated outline title, and feed the new multimedia content back to the client as the third multimedia content. After receiving the third multimedia content, the client may display the third multimedia content in the dialog page.

Optionally, after the second multimedia content is displayed, the respective outline titles placed in the editable states and the corresponding initial content proportions may also be displayed in response to the editing operation for the second multimedia content. Thereafter, the updated respective outline titles and corresponding target content proportions thereof may be acquired and sent to the server, and the server uses the artificial intelligence model to generate the third multimedia content and feeds it back to the client. After receiving the third multimedia content, the client may display the third multimedia content in the dialog page.

Based on the above embodiments, after generation indication information is received, a content structure and a content summary of the multimedia content to be generated may be displayed by displaying multimedia outline information such as an outline title and an initial content proportion, thus facilitating the user to quickly understand the multimedia content to be generated. By acquiring a target content proportion in response to a proportion adjustment operation and displaying a first multimedia content generated by using the target content proportion, the content structure and specific content of the multimedia content to be generated can be adjusted in time by using the target content proportion corresponding to respective outline titles, so as to quickly obtain the first multimedia content that is more in line with expectations. Compared with the case that the expected result can only be obtained by re-entering the adjusted question, the embodiment of the present disclosure can acquire in time adjustment information (i.e., the target content proportions) for the multimedia content in a process of generating the multimedia content, by displaying the outline titles and the initial content proportions of the multimedia content to be generated and receiving modifications for the initial content proportions. Then, the content structure and content information of the multimedia content to be generated are modified in time by using the adjustment information, and the first multimedia content is in line with the expectations is outputted. By receiving the adjustment information in the process of generating, the modification flexibility can be improved, and the path for acquiring the expected multimedia content can be effectively shortened, thus improving the efficiency of generating the multimedia content.

It can be understood by those skilled in the art that in the above-mentioned method of specific implementation, the order in which the steps are written does not imply a strict order of execution which imposes any limitation to the implementation process, and the exact order in which the steps are executed should be determined by their functions and possible inherent logics.

Based on the same inventive concept, an embodiment of the present disclosure also provides an apparatus for generating a multimedia content corresponding to the method for generating a multimedia content. Since the apparatus in the embodiment of the present disclosure has similar principle of solving problems as the above-mentioned method for generating a multimedia content in the embodiment of the present disclosure, the implementation of the apparatus can refer to the implementation of the method, and the repeated parts are omitted here.

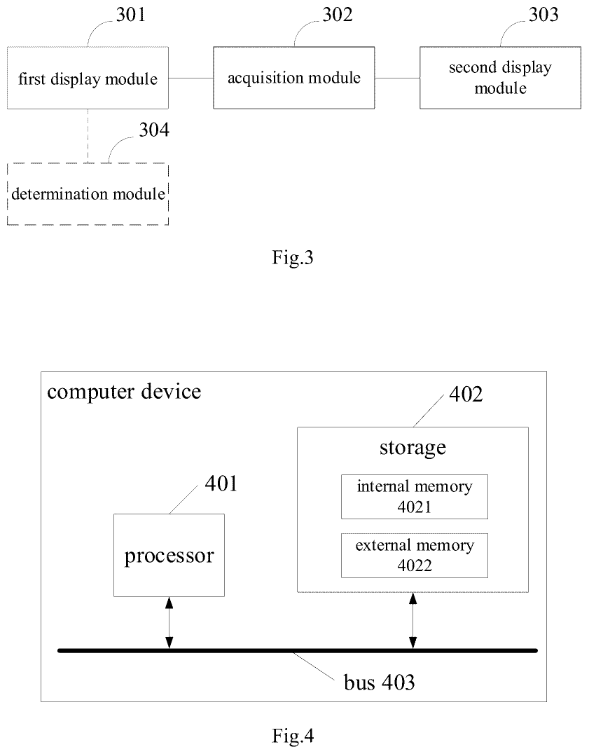

As shown in FIG. 3, it shows a schematic diagram of an apparatus for generating a multimedia content provided by an embodiment of the present disclosure, including:
a first display module 301, configured to receive generation indication information for a multimedia content and display multimedia outline information matched with the generation indication information, the multimedia outline information including at least one outline title and an initial content proportion corresponding to a target content under each outline title, the multimedia outline information being determined according to dimension information corresponding to the generation indication information under at least one attribute dimension;
an acquisition module 302, configured to acquire a target content proportion of the target content under each outline title in response to a proportion adjustment operation for the initial content proportion; and
a second display module 303, configured to display a first multimedia content matched with the generation indication information, the first multimedia content being generated according to the target content proportion corresponding to each outline title.

In a possible implementation, the multimedia outline information further includes a preview content under each outline title; the preview content is summary information in the target content under the outline title, and is used to characterize a correlation degree between the target content under the outline title and the generation indication information;
the first displaying module 301, after displaying the multimedia outline information matched with the generation indication information, is further configured to:
receive a modification operation for any of the outline titles to acquire an updated outline title; and
replace the modified outline title with the updated outline title and replace the preview content under the modified outline title with the preview content under the updated outline title.

In a possible implementation, the second display module 303, after displaying the multimedia outline information matched with the generation indication information, is further configured to:
in response to triggering a generation operation, display a second multimedia content matched with the generation indication information, the second multimedia content being generated according to the initial content proportion corresponding to each outline title.

In a possible implementation, the apparatus further includes:
a determination module 304, configured to determine the multimedia outline information according to the following steps:
performing semantic recognition on the generation indication information by using an artificial intelligence model, to determine first semantic information of the generation indication information;
determining, according to the first semantic information, corresponding dimension information under a plurality of attribute dimensions and content materials related to the dimension information; and
generating the multimedia outline information according to the dimension information and the content materials.

In a possible implementation, the attribute dimension includes at least one selected from the group consisting of a vertical field dimension, a timeliness dimension, an application scenario dimension, a content opposition dimension and a content type dimension.

In a possible implementation, when the generation indication information is article generation indication information and the attribute dimension includes a content type dimension, the determination module 304 is configured to determine the multimedia outline information according to the following steps:
performing semantic recognition on the article generation indication information by using the artificial intelligence model to determine second semantic information of the article generation indication information;
determining, according to the second semantic information, an article type of an article to be generated that is matched with the article generation indication information under the content type dimension, and article materials that are matched with the article generation indication information; and
generating the multimedia outline information according to the article type and the article materials.

In a possible implementation, the determination module 304, when generating the multimedia outline information according to the article type and the article materials, is configured to:
determine respective target outlines corresponding to the article type according to the article type and a pre-established association relationship between the article type and the outline; and
determine the outline title corresponding to each target outline, and the initial content proportion and the preview content corresponding to each outline title, according to the article materials.

In a possible implementation, the first display module 301, when receiving generation indication information for a multimedia content and displaying multimedia outline information matched with the generation indication information, is configured to:
receive the generation indication information, and display the multimedia outline information and a proportion adjustment identifier;
the acquisition module 302, when acquiring a target content proportion of the target content under each outline title in response to a proportion adjustment operation for the initial content proportion, is configured to:
place the respective initial content proportions in an editable state in response to triggering the proportion adjustment identifier; and
acquire the target content proportion corresponding to each outline title in response to an editing operation for the initial content proportion in the editable state, where a sum of the target content proportions corresponding to the respective outline titles is a preset value.

In a possible implementation, the first display module 301, after displaying the first multimedia content matched with the generation indication information, is further configured to:
display the target content proportion corresponding to each outline title in response to the editing operation for the first multimedia content;
the acquisition module 302, after displaying the first multimedia content matched with the generation indication information, is further configured to:
acquire a new target content proportion corresponding to each outline title in response to the adjustment operation for the target content proportion; and
the second presentation module 303, after displaying the first multimedia content matched with the generation indication information, is further configured to:
display a third multimedia content, the third multimedia content being generated according to the new target content proportion corresponding to each outline title by using the artificial intelligence model.

The description of a processing flow of each module in the apparatus and an interaction flow between the modules may refer to the relevant description in the foregoing method embodiment and will not be described in detail here.

Based on the same technical concept, an embodiment of the present application also provides a computer device. Referring to FIG. 4, it shows a structural schematic diagram of a computer device provided by an embodiment of the present application. The computer device includes:
a processor 401, a storage 402, and a bus 403, where the storage 402 stores machine-readable instructions executable by the processor 401, and the processor 401 is used for executing the machine-readable instructions stored in the storage 402. When the machine-readable instructions are executed by the processor 401, the processor 401 performs the following steps: S101: receiving generation indication information for a multimedia content and displaying multimedia outline information matched with the generation indication information, the multimedia outline information including at least one outline title and an initial content proportion corresponding to a target content under each outline title, the multimedia outline information being determined according to dimension information corresponding to the generation indication information under at least one attribute dimension; S102: acquiring a target content proportion of the target content under each outline title in response to a proportion adjustment operation for the initial content proportion; and S103: displaying a first multimedia content matched with the generation indication information; the first multimedia content being generated according to the target content proportion corresponding to each outline title.

The storage 402 includes an internal memory 4021 and an external memory 4022. The internal memory 4021 here is also called an internal storage, which is used for temporarily storing operation data in the processor 401 and data exchanged with the external memory 4022 such as a hard disk. The processor 401 exchanges data with the external memory 4022 through the internal memory 4021, and when the computer device is running, the processor 401 is communicated with the memory 402 through the bus 403, so that the processor 401 executes the execution instructions mentioned in the foregoing method embodiment.

An embodiment of the present disclosure also provides a computer-readable storage medium having stored thereon a computer program which, when run by a processor, executes the steps of the method for generating a multimedia content described in the foregoing method embodiment. The storage medium may be a volatile or nonvolatile computer-readable storage medium.

The computer program product of the method for generating a multimedia content provided in embodiments of the present disclosure includes a computer-readable storage medium that stores program codes. The instructions included in the program code can be used to execute the steps of the method for generating a multimedia content described in the above method embodiment. The above method embodiment can be referred for details, which will not be repeated here.

The computer program product can be specifically implemented through a hardware, a software, or a combination thereof. In an optional embodiment, the computer program product is specifically embodied as a computer storage medium, while in another optional embodiment, the computer program product is specifically embodied as a software product, such as a Software Development Kit (SDK), etc.

Those skilled in the art can clearly understand that for the convenience and conciseness of the description, the specific operating process of the system and device described above can refer to the corresponding process in the afore-mentioned method embodiments, which will not be repeated here. In the several embodiments provided in the present disclosure, it should be understood that the disclosed system, apparatus, and methods may be implemented in other ways. The apparatus embodiments described above are only illustrative. For example, the division of units is only a logical function division, and there may be other division methods in actual implementation. For example, multiple units or components can be combined or integrated into another system, or some features can be ignored or not executed. Another point is that the coupling or direct coupling or communication connection displayed or discussed between each other can be indirect coupling or communication connection through some communication interfaces, apparatuses or units, which can be electrical, mechanical or other forms.

The units described as separate components can be or may not be physically separated, and the components displayed as units can be or may not be physical units, that is, they can be located in one place or distributed across multiple network units. Some or all of the units can be selected according to actual needs to achieve the purpose of the embodiment.

In addition, each functional unit in the various embodiments of the present disclosure can be integrated into one processing unit, and can also exist physically separately, or two or more units can be integrated into one unit.

If the function is implemented in the form of a software functional unit and sold or used as an independent product, it can be stored in a non-volatile computer-readable storage medium that can be executed by a processor. Based on this understanding, the technical solution of the present disclosure can be embodied as a software product. The computer software product is stored in a storage medium and includes several instructions to enable a computer device (which can be a personal computer, server, or network device, etc.) to perform all or part of the steps of the methods described in the various embodiments of the present disclosure. The afore-mentioned storage medium includes: a USB flash drive, a portable hard drive, Read Only Memory (ROM), Random Access Memory (RAM), a magnetic disk or a light disk, and other media that can store program codes.

If the technical solution of the present application involves personal information, the product applying the technical solution of the present application has been clearly informed of the personal information processing rules and obtained individual independent consent before processing the personal information. If the technical solution of the present application involves sensitive personal information, the product applying the technical solution of the present application has obtained individual independent consent before processing the sensitive personal information, and it also meets the requirements of “express consent”. For example, at personal information collection apparatuses such as a camera, a clear and obvious sign is provided to inform that an individual has enter a personal information collection range in which personal information will be collected, and if an individual voluntarily enters the collection range, it will be regarded as agreeing to collect his personal information; or on a personal information processing apparatus, under the condition that the personal information processing rules are informed by the obvious sign/information, personal authorization is obtained by pop-up information or asking individuals to upload their personal information by themselves, where the personal information processing rules may include a personal information processor, personal information processing purposes, processing methods, types of personal information processed and other information.

Finally, it should be noted that the above embodiments are only specific embodiments of the present disclosure, used to illustrate the technical solution of the present disclosure, and not to limit it. The scope of protection of the present disclosure is not limited to this. Although detailed explanations of the present disclosure have been made with reference to the aforementioned embodiments, those skilled in the art should understand that any technical personnel familiar with the art can still modify or easily think of changes to the technical solution recorded in the aforementioned embodiments within the scope of the technology disclosed by the present disclosure, or replace some of the technical features equally; and these modifications, changes, or replacements do not make the essence of the corresponding technical solution deviate from the spirit and scope of the technical solution of the present disclosure, and should be covered within the scope of protection of the present disclosure. Therefore, the scope of protection of the present disclosure shall be based on the scope of protection of the claims.

1. A method for generating a multimedia content, comprising:
receiving generation indication information for a multimedia content and displaying multimedia outline information matched with the generation indication information, the multimedia outline information comprising at least one outline title and an initial content proportion corresponding to a target content under each outline title, the multimedia outline information being determined according to dimension information corresponding to the generation indication information under at least one attribute dimension;
acquiring a target content proportion of the target content under each outline title in response to a proportion adjustment operation for the initial content proportion; and
displaying a first multimedia content matched with the generation indication information; the first multimedia content being generated according to the target content proportion corresponding to each outline title.

2. The method according to claim 1, wherein the multimedia outline information further comprises a preview content under each outline title; the preview content is summary information in the target content under the outline title, and is used to characterize a correlation degree between the target content under the outline title and the generation indication information;
after displaying the multimedia outline information matched with the generation indication information, the method further comprises:
receiving a modification operation for any of the outline titles to acquire an updated outline title; and
replacing the modified outline title with the updated outline title and replacing the preview content under the modified outline title with the preview content under the updated outline title.

3. The method according to claim 1, wherein after the displaying the multimedia outline information matched with the generation indication information, the method further comprises:
in response to triggering a generation operation, displaying a second multimedia content matched with the generation indication information, the second multimedia content being generated according to the initial content proportion corresponding to each outline title.

4. The method according to claim 1, wherein the multimedia outline information is determined according to the following steps:
performing semantic recognition on the generation indication information by using an artificial intelligence model, to determine first semantic information of the generation indication information;
determining, according to the first semantic information, corresponding dimension information under a plurality of attribute dimensions and content materials related to the dimension information; and
generating the multimedia outline information according to the dimension information and the content materials.

5. The method according to claim 1, wherein the attribute dimension comprises at least one selected from the group consisting of a vertical field dimension, a timeliness dimension, an application scenario dimension, a content opposition dimension and a content type dimension.

6. The method according to claim 5, wherein when the generation indication information is article generation indication information and the attribute dimension comprises the content type dimension, the multimedia outline information is determined according to the following steps:
performing semantic recognition on the article generation indication information by using the artificial intelligence model to determine second semantic information of the article generation indication information;
determining, according to the second semantic information, an article type of an article to be generated that is matched with the article generation indication information under the content type dimension, and article materials that are matched with the article generation indication information; and
generating the multimedia outline information according to the article type and the article materials.

7. The method according to claim 6, wherein the generating the multimedia outline information according to the article type and the article materials comprises:
determining respective target outlines corresponding to the article type according to the article type and a pre-established association relationship between the article type and the outline; and
determining the outline title corresponding to each target outline, and the initial content proportion and the preview content corresponding to each outline title, according to the article materials.

8. The method according to claim 1, wherein the receiving generation indication information for a multimedia content and displaying multimedia outline information matched with the generation indication information comprises:
receiving the generation indication information, and displaying the multimedia outline information and a proportion adjustment identifier;
the acquiring a target content proportion of the target content under each outline title in response to a proportion adjustment operation for the initial content proportion comprises:
placing respective the initial content proportions in an editable state in response to triggering the proportion adjustment identifier; and
acquiring the target content proportion corresponding to each outline title in response to an editing operation for the initial content proportion in the editable state, wherein a sum of the target content proportions corresponding to the respective outline titles is a preset value.

9. The method according to claim 1, wherein after displaying the first multimedia content matched with the generation indication information, the method further comprises:
displaying the target content proportion corresponding to each outline title in response to the editing operation for the first multimedia content;
acquiring a new target content proportion corresponding to each outline title in response to the adjustment operation for the target content proportion; and
displaying a third multimedia content, the third multimedia content being generated according to the new target content proportion corresponding to each outline title by using an artificial intelligence model.

10. A computer device, comprising: at least one processor and at least one memory, wherein the at least one memory stores machine-readable instructions executable by the at least one processor, and the at least one processor is used for executing the machine-readable instructions stored in the at least one memory, and when the machine-readable instructions are executed by the at least one processor, the processor executes a method for generating a multimedia content, and the method comprises:
receiving generation indication information for a multimedia content and displaying multimedia outline information matched with the generation indication information, the multimedia outline information comprising at least one outline title and an initial content proportion corresponding to a target content under each outline title, the multimedia outline information being determined according to dimension information corresponding to the generation indication information under at least one attribute dimension;
acquiring a target content proportion of the target content under each outline title in response to a proportion adjustment operation for the initial content proportion; and
displaying a first multimedia content matched with the generation indication information; the first multimedia content being generated according to the target content proportion corresponding to each outline title.

11. The computer device according to claim 10, wherein the multimedia outline information further comprises a preview content under each outline title; the preview content is summary information in the target content under the outline title, and is used to characterize a correlation degree between the target content under the outline title and the generation indication information;
after displaying the multimedia outline information matched with the generation indication information, the method further comprises:
receiving a modification operation for any of the outline titles to acquire an updated outline title; and
replacing the modified outline title with the updated outline title and replacing the preview content under the modified outline title with the preview content under the updated outline title.

12. The computer device according to claim 10, wherein after the displaying the multimedia outline information matched with the generation indication information, the method further comprises:
in response to triggering a generation operation, displaying a second multimedia content matched with the generation indication information, the second multimedia content being generated according to the initial content proportion corresponding to each outline title.

13. The computer device according to claim 10, wherein the multimedia outline information is determined according to the following steps:
performing semantic recognition on the generation indication information by using an artificial intelligence model, to determine first semantic information of the generation indication information;
determining, according to the first semantic information, corresponding dimension information under a plurality of attribute dimensions and content materials related to the dimension information; and
generating the multimedia outline information according to the dimension information and the content materials.

14. The computer device according to claim 10, wherein the attribute dimension comprises at least one selected from the group consisting of a vertical field dimension, a timeliness dimension, an application scenario dimension, a content opposition dimension and a content type dimension.

15. The computer device according to claim 14, wherein when the generation indication information is article generation indication information and the attribute dimension comprises the content type dimension, the multimedia outline information is determined according to the following steps:
performing semantic recognition on the article generation indication information by using the artificial intelligence model to determine second semantic information of the article generation indication information;
determining, according to the second semantic information, an article type of an article to be generated that is matched with the article generation indication information under the content type dimension, and article materials that are matched with the article generation indication information; and
generating the multimedia outline information according to the article type and the article materials.

16. The computer device according to claim 15, wherein the generating the multimedia outline information according to the article type and the article materials comprises:
determining respective target outlines corresponding to the article type according to the article type and a pre-established association relationship between the article type and the outline; and
determining the outline title corresponding to each target outline, and the initial content proportion and the preview content corresponding to each outline title, according to the article materials.

17. The computer device according to claim 10, wherein the receiving generation indication information for a multimedia content and displaying multimedia outline information matched with the generation indication information comprises:
receiving the generation indication information, and displaying the multimedia outline information and a proportion adjustment identifier;
the acquiring a target content proportion of the target content under each outline title in response to a proportion adjustment operation for the initial content proportion comprises:
placing respective the initial content proportions in an editable state in response to triggering the proportion adjustment identifier; and
acquiring the target content proportion corresponding to each outline title in response to an editing operation for the initial content proportion in the editable state, wherein a sum of the target content proportions corresponding to the respective outline titles is a preset value.

18. The computer device according to claim 10, wherein after displaying the first multimedia content matched with the generation indication information, the method further comprises:
displaying the target content proportion corresponding to each outline title in response to the editing operation for the first multimedia content;
acquiring a new target content proportion corresponding to each outline title in response to the adjustment operation for the target content proportion; and
displaying a third multimedia content, the third multimedia content being generated according to the new target content proportion corresponding to each outline title by using an artificial intelligence model

19. A non-transient computer-readable storage medium, wherein the computer-readable storage medium has stored thereon a computer program, and when the computer program is run by a computer device, the computer device executes a method for generating a multimedia content, and the method comprises:
receiving generation indication information for a multimedia content and displaying multimedia outline information matched with the generation indication information, the multimedia outline information comprising at least one outline title and an initial content proportion corresponding to a target content under each outline title, the multimedia outline information being determined according to dimension information corresponding to the generation indication information under at least one attribute dimension;
acquiring a target content proportion of the target content under each outline title in response to a proportion adjustment operation for the initial content proportion; and
displaying a first multimedia content matched with the generation indication information; the first multimedia content being generated according to the target content proportion corresponding to each outline title.

20. The non-transient computer-readable storage medium according to claim 19, wherein the multimedia outline information further comprises a preview content under each outline title; the preview content is summary information in the target content under the outline title, and is used to characterize a correlation degree between the target content under the outline title and the generation indication information;
after displaying the multimedia outline information matched with the generation indication information, the method further comprises:
receiving a modification operation for any of the outline titles to acquire an updated outline title; and
replacing the modified outline title with the updated outline title and replacing the preview content under the modified outline title with the preview content under the updated outline title.
